(19) United States
(12) Patent Application Publication
(10) Pub. No.: US 2008/0223449 A1
(43) Pub. Date: Sep. 18, 2008

(54) VALVE FOR AN INFLATABLE PRODUCT

(75) Inventors: Yiyun Culp, Wichita, KS (US); Michael Wayne Peterson, Park City, KS (US)

Correspondence Address: Kelly S Elsea, 3600 North Hydraullic, IP Legal- 11702, WICHITA, KS, 67219, US

(73) Assignee: The Coleman Company, Inc., Wichita, KS (US)

(21) Appl. No.: 12/129,934

(22) Filed: May 30, 2008

(30) Foreign Application Priority Data
Nov. 29, 2006 (US) PCT/US06/61352

(51) Int. Cl. F16K 15/20; F16K 31/44

(52) U.S. Cl. 137/232; 137/523

(57) ABSTRACT

A valve (20) for an inflatable product. One valve includes a cap (56) that provides a double seal (58, 60). An inner seal (58) closes an opening (66) for the valve (20). The inner seal (58) and the opening (66) are mounted in a chamber, and the chamber is closed by a second, outer seal (60) that provides a backup in case of failure of the inner seal (58). A flapper valve (22) may be used as another seal. Another embodiment of a valve (120) includes a rigid cap (124). Still another embodiment of a valve (220) includes a plug (232) that is attached to a valve opening. Moving the valve opening forward and backward plugs a rear opening (230) in the valve, closing the valve (220).

### REFERENCE TO RELATED APPLICATION

This application claims the benefit of PCT/US06/61352, filed Nov. 29, 2006, which claims the benefit of U.S. provisional patent application Ser. No. 60/741,988, filed Dec. 1, 2005, both of which are incorporated herein by reference.

### TECHNICAL FIELD OF THE INVENTION

The present invention is directed to inflatable products, and more specifically to a valve for an inflatable product.

### BACKGROUND OF THE INVENTION

An airbed is a large rectangular rubber or plastic bag that is filled with air so that it may be used as a bed. An air mat is similar in construction to an airbed, but is used as a float so that an individual may lie on the air mat in the water. Both products fall under the broad category of “inflatable” products. Other nonlimiting examples of inflatable products include rafts, inflatable furniture, inflatable pools, and inflatable boats.

One thing inflatable products have in common is that they must be inflated for use. To this end, a valve or valves are supplied on an inflatable product for a user to provide air or another gas into the inflatable product. To inflate an inflatable product, a user may utilize his or her breath, i.e., by blowing into a valve or valves, may utilize a manual or electric pump, or may use an air compressor, as examples.

A variety of different valves are presently used for inflatable products. These valves have a common goal: to permit the user to easily inflate and deflate the product, while minimizing escaped air when the user tries to seal the product. Examples of conventional valves are the pinch valve, the Boston valve, and a double lock valve sold by the assignee of the present invention, The Coleman Company, Inc.

While present valves work well for their intended purpose, very few valves are useful in both allowing simple inflation and deflation of the product and allowing quick closure so that air is not lost from the inflatable product after the inflatable product is full. That is, for most prior art valves, when a user has inflated a product, a cap or other structure must be placed over the valve before air is lost. Often, a substantial amount of air is lost before the valve is sufficiently closed. Additionally, the valve may be difficult to use for deflation of the inflatable product.

### SUMMARY OF THE INVENTION

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

In accordance with a first embodiment, a valve is provided for an inflatable product. The valve includes a cap that provides a double seal. An inner seal closes an opening for the valve. The inner seal and the opening are mounted in a chamber, and the chamber is closed by a second, outer seal that provides a backup in case of failure of the inner seal.

In accordance with an embodiment, a flapper valve is provided on a valve for an inflatable product. A structure is provided that permits a user to press the flapper valve open so that the inflatable product may be deflated. In addition, when air is forced in through the valve, such as via a pump, the flapper valve is opened by the flow of air. Pressure within the inflatable product forces the flapper valve shut when an obstruction or air flow into the inflatable product is not pressing the flapper valve open.

In an embodiment, projections extend downward from a flexible cone for the valve. A flexible cone may be manipulated between a first position in which a cap may seal a top of the cone and the flapper valve is not engaged by the rigid projections, and a second position in which the flexible cone is collapsed and the rigid projections extend into the flapper valve and permit air to flow through the flapper valve and out of the inflatable product. In an embodiment, the flexible cone may lock in the second position so that the inflatable product may be deflated.

In accordance with an embodiment, a rigid cap may be provided on a housing for the valve, for example around the flexible cone, so that the valve may be locked. The rigid cap may include a double seal such as is described above.

In accordance with another embodiment, a valve is provided having a flexible cone configuration that is collapsible. A plug is connected to the bottom of the flexible cone configuration and is aligned with an opening in a housing for the valve. By collapsing the flexible cone, the plug closes the opening, blocking airflow into and out of the valve.

Other features of the invention will become apparent from the following detailed description when taken in conjunction with the drawings, in which:

### BRIEF DESCRIPTION OF THE DRAWINGS

FIG. 1 is an exploded side perspective view of a valve in accordance with an embodiment;

FIG. 2 is a side perspective view of the valve of FIG. 1, with the valve opened to expose a double-seal cap;

FIG. 3 is a sectional view of the valve of FIGS. 1 and 2, with the valve closed;

FIG. 4 is a side perspective view of a bottom portion of the valve in FIG. 1, with a flapper valve for the valve opened;

FIG. 5 is a side perspective view of a bottom of a flexible cone for the valve of FIG. 1;

FIG. 6 is a side perspective view of pieces for a valve in accordance with another embodiment;

FIG. 7 is an exploded side perspective view of a valve in accordance with yet another embodiment;

FIG. 8 is a side perspective view of a housing for the valve of FIG. 7; and

FIG. 9 is a sectional view of the valve of FIG. 7, with the valve shown assembled.

### DETAILED DESCRIPTION

In the following description, various embodiments of the present invention will be described. For purposes of explanation, specific configurations and details are set forth in order to provide a thorough understanding of the embodiments. However, it will also be apparent to one skilled in the art that the present invention may be practiced without the specific details. Furthermore, well-known features may be omitted or simplified in order not to obscure the embodiment being described.

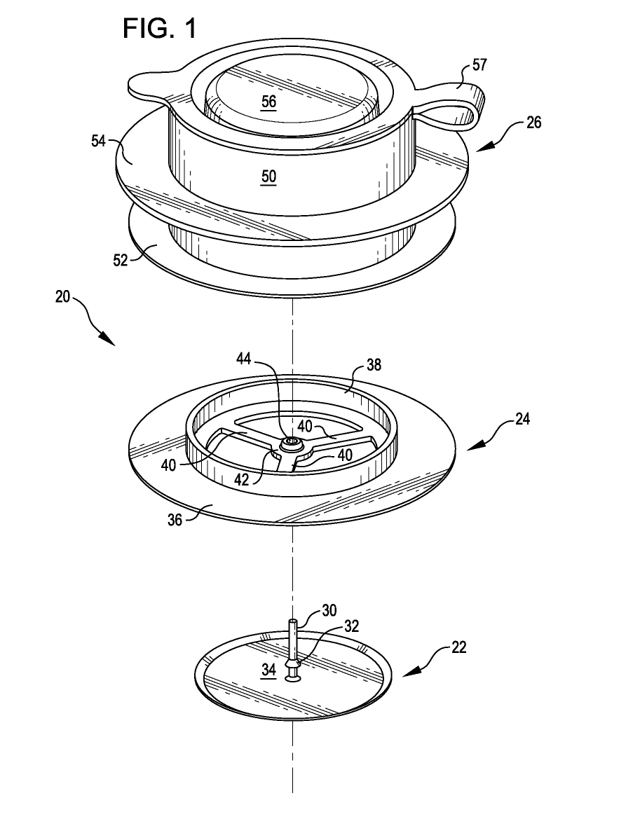

Referring now to the drawings, in which like reference numerals represent like parts throughout the several views, FIG. 1 shows a valve 20 in accordance with an embodiment of the invention. In general, the present invention is directed to valves for inflatable products such as airbeds, air mats, rafts, inflatable furniture, inflatable pools, inflatable boats, or other inflatable products.

The valve 20 includes a flapper valve 22, a flapper valve holder 24, and a double seal cap 26. The flapper valve 22 includes a stem 30 having a flange 32 part way up its length. A flexible membrane 34 is attached to the bottom of the stem 30. The flexible membrane 34 may be formed, for example, of rubber, a flexible plastic, or another suitable material. In an embodiment, the stem 30 and the flexible membrane 34 are molded as a single part.

The flapper valve holder 24 includes an outer rim 36 attached to a cylindrical base 38. Spokes 40 extend inward from the cylindrical base 38 to a central hub 42. An opening 44 is positioned at the center of the central hub 42.

In the embodiment shown, three spokes 40 are utilized, but any number may be used, and the flapper valve holder 24 and other parts of the valve 20 may be arranged differently than shown in the drawings.

To assemble the flapper valve 22 and the flapper valve holder 24, the stem 30 of the flapper valve 22 is inserted into the opening 44 of the flapper valve holder 24. A laborer pulls the stem 30 through until the flange 32 pops over the top of the central hub 42. To this end, in an embodiment, the flange 32 is formed of a material that can compress so that it may go through the opening 44, but returns to its original shape after going through the opening. The flange 32 holds the flapper valve 22 into position against the bottom of the flapper valve holder 24. Once in place, the flapper valve 22 closes off a large opening at the bottom of the flapper valve holder 24.

The flapper valve 22 is preferably formed of a material that is sufficiently flexible to bend open from air flowing into the valve 20 (e.g., via a pump), but is resilient so that it returns to a position against the opening at the bottom of the flapper valve holder 24 after the air is no longer flowing through the valve. To this end, without structural intervention, the flapper valve 22 is a one-way valve.

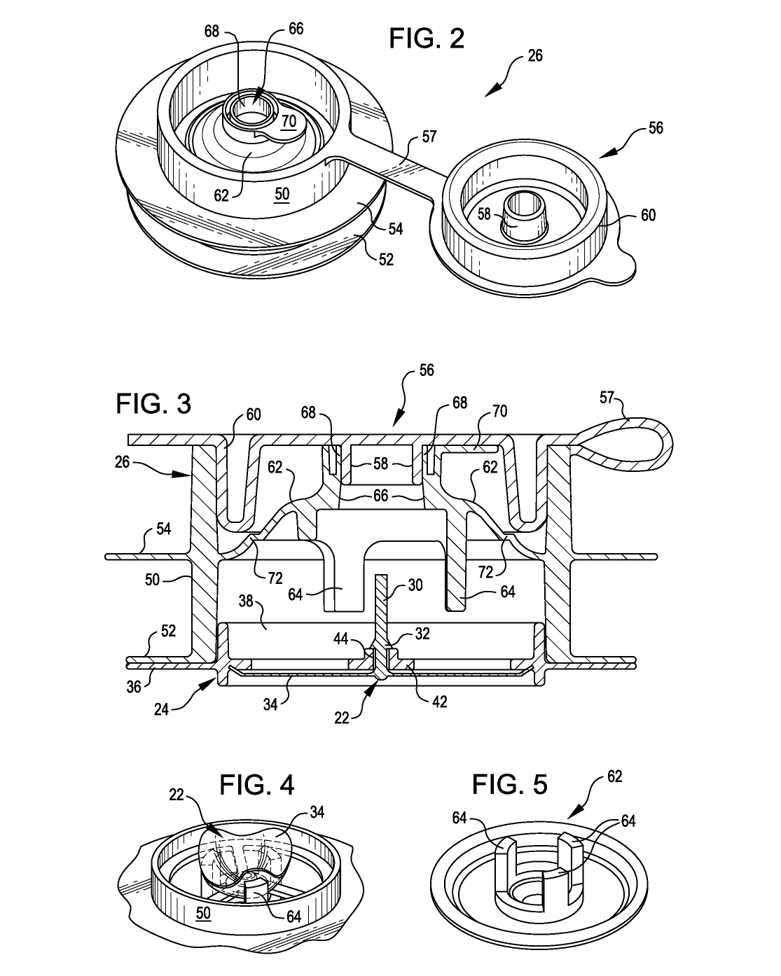

The double seal cap 26 is shown in more detail in FIG. 2. The double seal cap 26 includes a housing 50 having a lower outer rim 52 and an upper outer rim 54. A cap 56 is attached to the top of the housing 50 via a flap 57. The cap 56 includes an inner seal 58 and an outer seal 60. The inner seal 58 is concentric with the outer seal 60, but other arrangements may be provided.

Inside the housing 50 is mounted a flexible cone 62. The flexible cone 62 is positioned so that its apex is at the top of the housing 50 (i.e. at the section that faces the cap 56 when the cap is in position).

As shown in FIG. 3, the flexible cone 62 includes projections 64 extending downward from a bottom side of the flexible cone 62. In the embodiment shown, the number of rigid projections 64 is three (see FIG. 5), but any suitable number may be used.

The top of the flexible cone 62 includes an opening 66. A lip 68 is formed in the opening by a groove that is cut just outside of the lip.

The housing 50 and the flexible cone 62 may be formed of the same material, and the housing 50 may be made more rigid by having its side walls thicker than the side walls of the flexible cone 62. However, in an alternative embodiment, the flexible cone 62 is formed of a different material than the housing 50, and may be, for example, rubber, and is joined to the housing, for example via welding. The housing 50 is preferably formed of a material, or its edges are overmolded to a material (for example at the upper outer ring 54), that may be welded to, heat fused to, or otherwise attached to the inflatable product. As an example, the upper outer ring 54 may be formed of polyvinyl chloride (PVC) that may be welded to sides of the inflatable product. In the embodiment shown in the drawing, the outer rim 36 of the flapper valve holder 24 is connected to the lower outer ring 52, for example by welding.

The cap 56 provides a dual sealing function at the top of the valve 20. The inner seal 58 fits within the opening 66 on the top of the flexible cone 62. The lip 68 formed at the top of the flexible cone 62 permits the opening 66 to flex to accommodate the inner seal 58.

The outer seal 60 fits against the inner edge of the housing 50. This outer seal 60 closes the cap 56 around and over the flexible cone 62, which with the housing forms a chamber. This chamber is closed by the outer seal 60 when the cap 56 is in place. Thus, the outer seal 60 provides a secondary seal if there is leaking at the inner seal 58.

The flapper valve 22 provides a third seal for the valve 20. When the inflatable product is full of pressurized air, the pressure of the air on the back of the flexible membrane 34 of the flapper valve 22 presses the flapper valve 22 closed against the back of the flapper valve holder 24. The sealing action of the flapper valve 22 does not require action by a user, but instead seals automatically. The seal is made stronger when there is pressurized air within the inflatable product.

Thus, the valve 20 has three seals for preventing air leakage: the flapper valve 22, the inner seal 58, and the outer seal 60. These three seals ensure that the valve 20 does not leak during use.

To inflate an inflatable product using the valve 20, a user opens the cap 56, releasing the inner and outer seals 58, 60. A pump may be attached to the opening 66 of the flexible cone 62. Air is then blown through the flexible cone 62. The pressure of the air flowing through the flexible cone 62 opens the flapper valve 22 by blowing the flexible membrane 34 open. The amount the flexible membrane 34 moves out of the way is dependent upon the amount of air flowing through the valve 20 and the flexibility of the flexible membrane 34.

After the inflatable product is fully inflated, the user may simply shut off the pump or disconnect the pump from the opening 66. The flexible membrane 34 then seats back against the bottom of the flapper valve holder 24, sealing the opening to the valve 20. The pressurized air within the inflatable product presses the flexible membrane 34 in place, and seals the flapper valve 22 to the flapper valve holder 24. As such, air is prevented from flowing out of the valve 20. Thus, the valve 20 provides rapid closure after inflation so that air is not lost from the inflatable product after the inflatable product is fully inflated. The user may then close the cap 56, which provides two more closures of the valve 20 via the inner and outer seals 58, 60.

To deflate an inflatable product with the valve 20, the user opens the cap 56. The user then presses the top of the flexible cone 62 inward into the housing 50. The flexible nature of the flexible cone 62 permits the flexible cone to collapse, driving the rigid projections 64 into the flexible membrane 34 of the flapper valve 22. In an embodiment, the rigid projections 64 are positioned so that they extend between the spokes 40 of the flapper valve holder 24. In this manner, the projections 64 may press the flexible membrane 34 away from the bottom of the flapper valve holder 24, opening an air passage.

As shown in FIG. 4, the rigid projections 64 provide an opening at the bottom of the valve 20 for permitting air to flow out of the flapper valve holder 24. This air flows out of the opening 66 in the flexible cone 62 and thus out of the valve 20. In an embodiment, the flexibility of the flexible cone 62 is sufficient so that the flexible cone may hold itself in position at this collapsed state and user intervention is required to return it to its normal state. To this end, a flange 70 is provided at the top of the flexible cone 62 for permitting a user to pull outward on the flexible cone. In addition, as can be seen in FIG. 3, a shelf 72 is provided on the upward tier of the flexible cone 62 at which the cone folds inward on itself when in the collapsed position. The shelf 72 also serves as a guide to aid in uniform collapsing of the flexible cone 62 so that the projections 64 are directed straight downward upon collapse.

In accordance with another embodiment, a second valve 120 (FIG. 6) is provided that is similar to the valve 20. However, instead of having the cap 56, the outer portion of the housing 50 includes external threads 122 onto which is fitted a locking lid 124. This locking lid 124 is a rigid cap and may include inner and outer seals 126, 128 that are similar to the inner and outer seals 58, 60 of the valve 20. The locking lid 124 may include a groove or internal threads to thread onto the external threads 122.

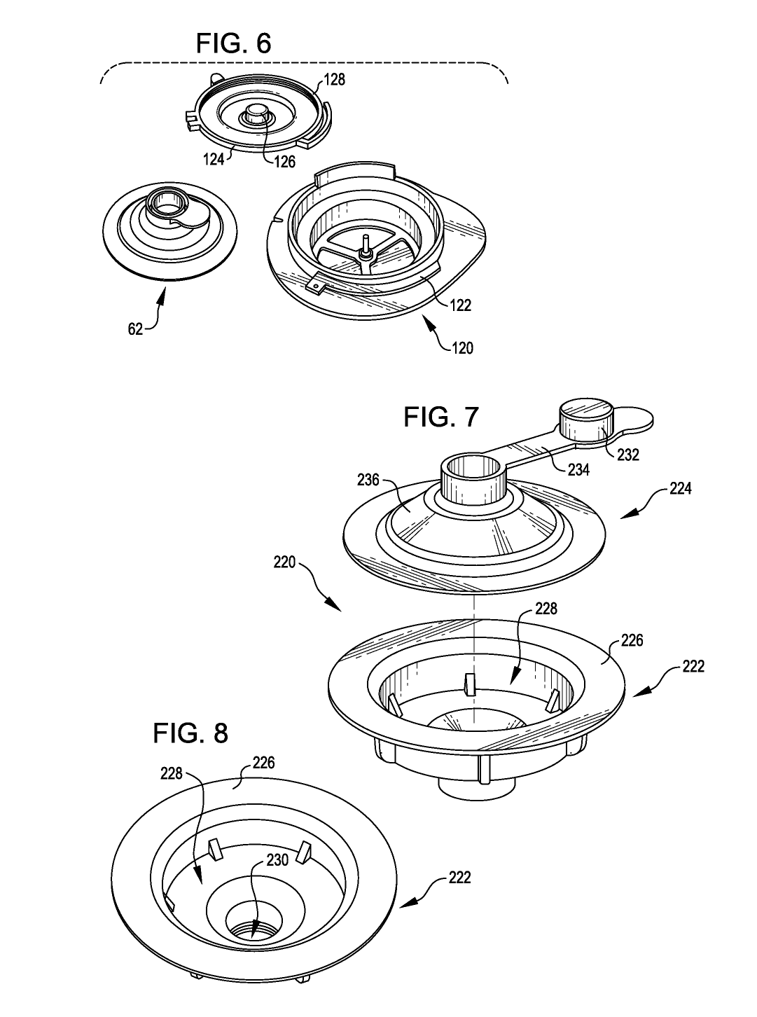

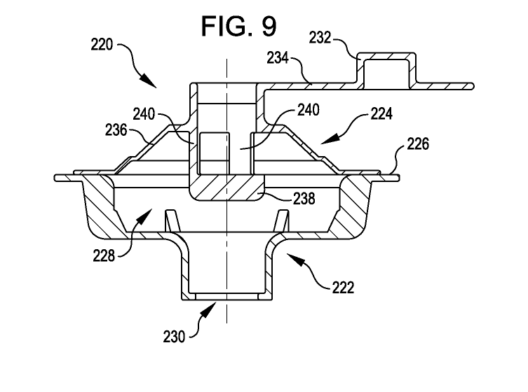

A valve 220 in accordance with another embodiment is shown in FIG. 7. The valve 220 includes a valve housing 222 and a flexible cone 224. The valve housing 222 includes a rim 226, an inner chamber 228, and an opening 230 on a bottom. The flexible cone 224 fits on top of the rim 226 (see FIG. 9).

The flexible cone 224 is similar in structure to the flexible cone 62 for the valve 20. However, in the embodiment shown in the drawings, the flexible cone 224 is not mounted within a housing such as a housing 50, but instead is mounted on top of the valve housing 222. However, if desired, a similar housing to the housing 50 for the valve 20 may be mounted around the flexible cone 224. The valve 220 includes a plug 232 that is attached to the top of the flexible cone 224 by a flap 234. The plug 232 may extend into an opening for the flexible cone 224 to close the flexible cone. As an alternative, the top of the flexible cone 224 may be sealed by a double sealed cap, such as the cap 56 for the valve 20.

As with the flexible cone 62, the flexible cone 224 includes flexible sides 236 that permit the flexible cone to be collapsed by a user. In addition, as is shown in FIG. 9, the flexible cone 224 includes a lower plug 238 that is attached to the bottom of the flexible cone. As an example, legs 240 may extend downward from the bottom of the opening for the flexible cone 224 to the lower plug 238. If desired, the lower plug 238 may be formed of a different, more rigid, material than the flexible cone 224, and as such may be overmolded or otherwise attached to the flexible cone 224.

In the position shown in FIG. 9, the valve 220 is open and air is free to flow into or out of the valve. The air flows through the opening in the flexible cone 224 and through the opening 230 in the bottom of the valve housing 222. A user that wishes to inflate an inflatable product attaches a pump to the valve while the valve is in the position shown in FIG. 9, and air is blown through the opening 230 into the inflatable product.

To close the valve 220, the user collapses the flexible cone 224 until the lower plug 238 is seated within the opening 230 at the bottom of the valve housing 222. The lower plug 238 thus seals the valve 220, stopping the flow of any additional air into or out of the inflatable product. The pump may remain on until the lower plug 238 is seated in the opening 230. A user may then shut off the pump.

Because the valve 220 may be closed while the pump is still on, there is little or no loss of air after the inflatable product is full. Air stops flowing into the inflatable product only after the valve 220 is fully closed, and at no point is there a flow of air in the opposite direction (i.e., out of the inflatable product). The pump may then be removed from the opening of the flexible cone 224, and the plug 232 may be used to close the top of the valve 220. Another suitable cap or closure may be used over the opening of the flexible cone 224. The plug 232 or other closure mechanism provides a back-up system to prevent leakage of air out of the inflatable product.

Other variations are within the spirit of the present invention. Thus, while the invention is susceptible to various modifications and alternative constructions, a certain illustrated embodiment thereof is shown in the drawings and has been described above in detail. It should be understood, however, that there is no intention to limit the invention to the specific form or forms disclosed, but on the contrary, the intention is to cover all modifications, alternative constructions, and equivalents falling within the spirit and scope of the invention, as defined in the appended claims.

The use of the terms “a” and “an” and “the” and similar referents in the context of describing the invention (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments of the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A valve for an inflatable product, the valve comprising a passageway having an inlet and an outlet, the valve comprising:
a housing defining a chamber, the chamber defining an outer opening;
an inner opening within the chamber and at the inlet of the passageway, the inner opening being movable between first and second positions; and
a cap comprising:
an outer seal mounted on the cap for sealing the outer opening;
an inner seal mounted on the cap for sealing the inner opening and preventing the flow of fluid between the inlet and the outlet when the outer seal is sealed to the outer opening and the inner opening is in the first position such that, when the outer seal is sealed to the outer opening, the inner opening is enclosed in the chamber and any fluid escaping through the inner opening is prevented from flowing out of the valve by the outer seal;
the inner opening being spaced from the inner seal when the outer seal is sealed to the outer opening and the inner seal is in the second position.

2. The valve of claim 1, further comprising a flexible, collapsible cone within the chamber, a top of the flexible cone defining the inner opening, the flexible cone being movable between:
an extended position where, when the outer seal is sealed to the outer opening, the inner opening on the flexible cone is sealed to the inner seal of the cap, and
a collapsed position where, when the outer seal is sealed to the outer opening, the inner opening on the flexible cone is spaced from the inner seal of the cap.

3. The valve of claim 2, further comprising a flapper valve, which in a normal state prevents flow from the outlet to the inlet.

4. The valve of claim 3, further comprising a protrusion on the flexible cone;
the flexible cone, the protrusion, and the flapper valve being arranged so that moving the flexible cone toward the collapsed position toward the flapper valve causes the protrusion to engage the flapper valve and the flapper valve to open, permitting fluid to flow through the flapper valve from the outlet toward the inlet.

5. The valve of claim 4, wherein the flexible cone comprises a structure that permits the flexible cone to lock into the collapsed position so that, when the flexible cone is locked in the collapsed position, the flapper valve remains open.

6. The valve of claim 5, wherein the structure comprises a step in the flexible cone.

7. The valve of claim 5, further comprising a tab connected to the cone for grasping and pulling the flexible cone out of the collapsed position.

8. The valve of claim 1, further comprising a flapper valve, which in a normal state prevents flow from the outlet to the inlet.

9. The valve of claim 1, wherein the cap and the housing each comprise threads, and the cap is threaded onto the housing to close the outer seal.

10. The valve of claim 1, wherein the cap and the housing are connected by a flap.

11. The valve of claim 10, wherein the cap, the housing, and the flap are formed as a single unit out of a single material.

12. An inflatable product comprising the valve of claim 1.

13. A valve for an inflatable product, the valve comprising a passageway with an inlet and an outlet, the valve comprising:
a housing defining the passageway therethrough;
a flexible, collapsible cone mounted to the housing across the passageway and defining a cone opening therethrough, the cone opening defining part of the passageway, the flexible cone being movable between an extended position and a collapsed position;
a plug mounted to an underside of the flexible cone for movement with the flexible cone, wherein movement of flexible cone to the collapsed position causes the plug to close the passageway, and movement of the flexible cone to the extended position removes the plug from closing the passageway; and
a cap for selectively closing the cone opening and thereby closing the passageway.

14. The valve of claim 13, further comprising a cap for selectively closing the opening on the flexible cone when the cone is in the extended position.

15. The valve of claim 14, wherein the flexible cone comprises a structure that permits the flexible cone to lock into the collapsed position.

16. The valve of claim 15, wherein the structure comprises a step in the flexible cone.

17. The valve of claim 16, wherein the cap and the flexible cone are connected by a flap.

18. The valve of claim 14, wherein the cap and the flexible cone are connected by a flap.

19. An inflatable product comprising the valve of claim 13.
